(19) United States
(12) Patent Application Publication
(10) Pub. No.: US 2016/0264769 A1
(43) Pub. Date: Sep. 15, 2016

(54) CURABLE COMPOSITIONS WHICH FORM INTERPENETRATING POLYMER NETWORKS

(71) Applicant: BLUE CUBE IP LLC, Midland, MI (US)

(72) Inventors: Xiaomei SONG, Shanghai (CN); Yonghua GONG, Shanghai (CN); Hongyu CHEN, Shanghai (CN); Tianhui XIAO, Shanghai (CN); Michael J. MULLINS, Houston, TX (US)

(21) Appl. No.: 15/032,111

(22) PCT Filed: Oct. 28, 2014
(86) PCT No.: PCT/US2014/062628

§ 371 Date: Apr. 26, 2016

(30) Foreign Application Priority Data
Oct. 31, 2013 (CN) PCTCN2013/086374

(51) Int. Cl. C08L 25/16; C08L 71/12; C08L 37/00; C08J 5/24; C08J 3/24

(52) U.S. Cl. CPC C08L 25/16; C08J 5/24; C08J 3/24; C08L 37/00; C08L 71/126; C08J 2325/16; C08J 2425/16; C08J 2463/00; C08J 2337/00; C08J 2371/12; C08J 2471/12; C08L 2201/02; C08L 2203/206; C08L 2205/035; C08L 2205/04

(57) ABSTRACT

A curable composition comprising a a) styrene-butadiene vinyl resin containing from 30 weight percent to 85 weight percent of 1,2-vinyl groups and wherein styrene is present in an amount in the range of from 10 weight percent to 50 weight percent; b) a vinyl poly(phenylene ether) having a number average molecular weight in the range of from 300 to 10000; c) an aniline modified styrene-maleic anhydride copolymer; d) a multifunctional epoxy resin; and e) a flame retardant wherein, upon curing under curing conditions, the curable composition forms at least one interpenetrating network structure, is disclosed. Methods for preparing the curable composition are also disclosed, as are prepregs and laminates made therefrom.

### FIELD OF DISCLOSURE

Embodiments of the present disclosure relate to curable compositions and in particular to curable compositions that include polymers that form interpenetrating polymer networks upon curing.

### BACKGROUND

Curable compositions are compositions that include thermosettable monomers that can be crosslinked. Crosslinking, also referred to as curing, converts curable compositions into crosslinked polymers (i.e., a cured product) useful in various fields such as, for example, composites, electrical laminates and coatings. Some properties of curable compositions and crosslinked polymers that can be considered for particular applications include mechanical properties, thermal properties, electrical properties, optical properties, processing properties, among other physical properties.

Curable compositions can be cured to form an interpenetrating polymer network (IPN). An IPN is a combination of two or more polymers that form a network, wherein at least one polymer is polymerized and/or crosslinked in the presence of the other polymers. Systems that can be dually cured are useful for forming an IPN.

Glass transition temperature, dielectric constant and dissipation factor are examples of properties that are considered highly relevant for curable compositions used in electrical laminates. For example, having a sufficiently high glass transition temperature for an electrical laminate can be very important in allowing the electrical laminate to be effectively used in high temperature environments. Similarly, decreasing the dielectric constant (Dk) and dissipation factor (Df) of the electrical laminate can assist in separating a current carrying area from other areas.

Styrene-butadiene copolymer (SBC) can be used to make low Dk and Df laminates due to its outstanding dielectric performance. A fully cured material made with SBC has relatively good thermal resistance. However, SBC-based prepregs normally have issues with stickiness and flammability. Additionally, the cured material has a glass transition temperature (Tg) which is lower than 150° C. Vinyl capped poly(phenylene ether) (PPO) has also been developed to make low Dk and Df laminates. The cured PPO has high Tg and good flame retardancy. However, its Dk and Df values are not as good as those of butadiene-based systems.

Therefore, an electrical laminate having low Dk and Df values, while not sacrificing other essential properties such as glass transition temperature and flame retardancy, is desired.

### SUMMARY

One broad aspect of the present invention discloses a curable composition comprising, consisting of, or consisting essentially of a) a styrene-butadiene vinyl resin containing from 30 weight percent to 85 weight percent of 1,2-vinyl groups and wherein styrene is present in an amount in the range of from 10 weight percent to 50 weight percent; b) a vinyl poly(phenylene ether) having a number average molecular weight in the range of from 300 to 10000; c) an aniline modified styrene-maleic anhydride copolymer; d) a multifunctional epoxy resin; and e) a flame retardant wherein, upon curing under curing conditions, the curable composition forms at least one interpenetrating network structure.

### DETAILED DESCRIPTION

Styrene-Butadiene Copolymer-Based Vinyl Resins Curable compositions of the present invention contain vinyl resins which are based on copolymers of butadiene and styrene. In an embodiment, the styrene-butadiene copolymer (SBC)-based vinyl resins contain from 1 to 99 weight percent 1,2-vinyl groups, contain from 30 weight percent to 85 weight percent 1,2-vinyl groups in other embodiments, and contain from 50 weight percent to 70 weight percent 1,2-vinyl groups in yet other embodiments. The SBC-based vinyl resin also has a styrene content in the range of from 1 to 99 weight percent in various embodiments, 10 to 50 weight percent in other embodiments, and from 15 to 30 weight percent in yet other embodiments, based on the total weight of the SBC-based vinyl resin.

Commercial examples of such styrene-butadiene copolymer based vinyl resins include, but are not limited to Ricon® 100 resin, Ricon® 181 resin, and Ricon® 184 resin, all from Cray Valley.

The SBC-based vinyl resin is generally present in the curable composition in an amount in the range of from 1 weight percent to 50 weight percent, based on the total weight of the curable composition. In other embodiments, the SBC-based vinyl resin is present in an amount in the range of from 5 weight percent to 40 weight percent, and is present in an amount in the range of from 15 weight percent to 35 weight percent in yet other embodiments.

In various embodiments, the SBC-based vinyl resin can have a number average molecular weight in the range of from 500 to 8000.

### Vinyl PPO

In various embodiments, the curable composition can further comprise a vinyl poly(phenylene ether) (PPO) compound.

The vinyl PPO compound generally has a number average molecular weight in the range of from 300 to 25000. In other embodiments, the vinyl PPO compound has a number average molecular weight in the range of from 800 to 10000, and has a number average molecular weight in the range of from 1500 to 4000 in yet other embodiments.

The vinyl PPO compound is generally present in the curable composition in an amount in the range of from 1 weight percent to 99 weight percent, based on the total weight of the curable composition. In another embodiment, the vinyl PPO compound is present in an amount in the range of from 25 weight percent to 75 weight percent, and is present in an amount in the range of from 30 weight percent to 60 weight percent in yet another embodiment.

Commercial examples of such PPO resins include, but are not limited to Noryl® SA9000 resin from SABIC and OPE-2St from Mitsubishi Gas Chemical Company, Inc.

The weight ratio of the SBC-based vinyl resin to the vinyl PPO compound is generally 1:5. In other embodiments, the weight ratio of the SBC-based vinyl resin to the vinyl PPO is 1:4, and is 1:2 in yet other embodiments.

The SBC-based vinyl resin and the vinyl PPO compound are generally present in the curable composition in an amount in the range of from 1 weight percent to 99 weight percent, based on the total weight of the curable composition. In other embodiments, the SBC-based vinyl resin and the vinyl PPO compound are present in an amount in the range of from 35 weight percent to 55 weight percent, and are present in an amount in the range of from 45 weight percent to 55 weight percent in yet other embodiments.

### Modified SMA

The curable composition also contains a styrene-maleic anhydride (SMA) copolymer modified with an aromatic amine compound. The styrene component can include the compound styrene having the chemical formula C₆H₅CH═CH₂ and compounds derived therefrom (e.g. styrene derivatives), unless explicitly stated otherwise. Maleic anhydride, which may also be referred to as cis-butenedioic anhydride, toxilic anhydride, or dihydro-2, 5-dioxofuran, has a chemical formula of C₂H₂(CO)₂O.

Commercial examples of such styrene-maleic anhydride copolymer include, but are not limited to, SMA® 1000, SMA® 2000, SMA® 3000, SMA® EF-30, SMA® EF-40, SMA® EF-60, and SMA® EF-80 all of which are available from Cray Valley.

The styrene and maleic anhydride copolymer is modified with an aromatic amine compound. In various embodiments, this compound can be aniline. The aromatic amine compound (e.g., aniline) can be used to react with part of the maleic anhydride groups in the styrene and maleic anhydride copolymer. This can result in a maleimide being present in the polymer. In an embodiment, the maleimide is N-phenylmaleimide.

The modified polymer can be obtained by combining a copolymer with a monomer via a chemical reaction, for example, reacting a styrene and maleic anhydride copolymer with the amine compound. Additionally, the polymer can be obtained by combining more than two species of monomer via a chemical reaction (e.g., reacting a styrenic compound, maleic anhydride, and maleic acid compounds). In an embodiment, the process for modifying the styrene and maleic anhydride can include imidization. In another embodiment, the styrene and maleic anhydride can be modified to an amic acid. The reacted monomers and/or copolymers form the constitutional units of the polymer.

The modified SMA copolymer is generally present in the curable composition in an amount in the range of from 1 weight percent to 99 weight percent, based on the total weight of the curable composition. In another embodiment, the modified SMA copolymer is present in an amount in the range of from 25 weight percent to 75 weight percent, and is present in an amount in the range of from 30 weight percent to 60 weight percent in yet another embodiment.

### Multifunctional Epoxy Resin

The curable composition also comprises a multifunctional epoxy resin.

Examples of multifunctional epoxy resins include, but are not limited to epoxy resins obtained by glycidifying the condensation product of a phenol or a naphthol with an aldehyde, such as naphthol-novalac type epoxy resins, or epoxy resins obtained by glycidifying the co-condensation product of naphthol, phenol and formaldehyde, or bisphenol A or F-novalac type epoxy resins, and mixtures of any two or more thereof. In various embodiments, D.E.R.® 560 can be used.

The multifunctional epoxy resin is generally present in the curable composition in an amount in the range of from 1 weight percent to 99 weight percent, based on the total weight of the curable composition. In other embodiments, the multifunctional epoxy resin is present in an amount in the range of from 25 weight percent to 75 weight percent, and is present in an amount in the range of from 30 weight percent to 60 weight percent in yet other embodiments.

### Flame Retardant

The curable composition can also comprise a flame retardant compound.

Examples of suitable flame retardants include, but are not limited to brominated resins or non-brominated resins, non-reactive brominated additives such as decabromodiphenyl ethane, N,N-ethylene-Bis(tetrabromophthal-imide), and tri(tribromophenyl) cyanurate), reactive brominated additives such as tetrabromobisphenol A bis(allylether) and dibromo styrene, non-brominated additives, phosphorous based flame retardant agents such as bisphenol-A bis(diphenyl phosphate), (Chemtura Reofos BAPP and Albemaarle NcendX P-30) and tetraphenyl resorcinol bis(diphenylphosphate) (Chemtura Reofos RDP) , and mixtures of any two or more thereof.

In various embodiments, flame retardants with functional groups that can react with vinyl systems or epoxy systems can be used, such as dibromostyrene (DBS) or tetrabromobisphenol A (TBBA). Non-reactive flame retardants which can be homogeneously dispersed in the varnish can also be used in various embodiments, such as 1,2-Bis(2, 3, 4, 5, 6-pentabromophenyl)ethane.

The flame retardant compound is generally present in the curable composition in an amount in the range of from 1 weight percent to 99 weight percent, based on the total weight of the SBC vinyl resin and vinyl PPO resin. In other embodiments, the flame retardant compound is present in an amount in the range of from 1 weight percent to 70 weight percent, and is present in an amount in the range of from 5 weight percent to 60 weight percent in yet other embodiments.

### Optional Components

In various embodiments, the curable composition can also include an initiator for free radical curing. Examples of such free radical initiators include, but are not limited to dialkyldiazenes (AIBN), diaroyl peroxides such as benzoyl peroxide (BPO), dicumyl peroxide (DCP), tert-butyl hydroperoxide (tBHP), cumene hydroperoxide (CHP), disulfides, and mixtures thereof. Commercial examples of free radical initiators that can be used in the present invention include, but are not limited to Luperox®-F4OP and Luperox®-101 from Arkema Company.

The free radical initiator can be generally present in the curable composition in an amount in the range of from 0.01 weight percent to 10 weight percent, based on the total weight of the SBC vinyl resin and vinyl PPO resin. In other embodiments, the free radical initiator is present in an amount in the range of from 0.1 weight percent to 8 weight percent, and is present in an amount in the range of from 2 weight percent to 5 weight percent in yet other embodiments.

In various embodiments, the curable composition can include a catalyst. Examples of the catalyst can include, but are not limited to, 2-methyl imidazole (2MI), 2-phenyl imidazole (2PI), 2-ethyl-4-methyl imidazole (2E4MI), 1-benzyl-2-phenylimidazole (1B2PZ), boric acid, triphenylphosphine (TPP), tetraphenylphosphonium-tetraphenylborate (TPP-k) and combinations thereof. For the various embodiments, the catalyst (10% solution by weight) can be used in an amount of from 0.01% to 2.0% by weight based on total solid component weight of the modified SMA resin and multifunctional epoxy resin.

In one or more embodiments, the curable composition can also include fillers. Examples of fillers include but are not limited to silica, talc, aluminum trihydrate (ATH), magnesium hydroxide, carbon black, and combinations thereof.

The filler can be generally present in the curable composition in an amount in the range of from 1 weight percent to 80 weight percent, based on the total weight of the curable composition. In other embodiments, the filler is present in an amount in the range of from 1 weight percent to 50 weight percent, and is present in an amount in the range of from 1 weight percent to 30 weight percent in yet other embodiments.

In one or more embodiments, the curable composition can contain a solvent. Examples of solvents that can be used include, but are not limited to methyl ethyl ketone (MEK), toluene, xylene, cyclohexanone, dimethylformamide (DMF), ethyl alcohol (EtOH), propylene glycol methyl ether (PM), propylene glycol methyl ether acetate (DOWANOL™ PMA) and mixtures thereof.

The solvent is generally present in the curable composition in an amount in the range of from 1 weight percent to 60 weight percent, based on the total weight of the curable composition. In other embodiments, the solvent is present in an amount in the range of from 1 weight percent to 50 weight percent, and is present in an amount in the range of from 30 weight percent to 40 weight percent in yet other embodiments.

### Process for Producing the Composition

The curable composition can be produced by any suitable process known to those skilled in the art. The components can be admixed in any combination or subcombination. In an embodiment, solutions of SBC-modified vinyl resin and vinyl PPO are mixed together and the epoxy resin and modified SMA are mixed together. The two mixtures are then mixed together. A flame retardant and initiator and catalyst can then be added, along with any other desired components described above, such as, for example, fillers.

For one or more embodiments, the curable composition can have a gel time of 70 seconds (s) to 250 s at 171° C. including all individual values and/or subranges therein. In another embodiment, the curable composition can have a gel time of 200 seconds to 250 seconds at 150° C. including all individual values and/or subranges therein. Gel time can indicate a reactivity of the curable compositions (e.g. at a specific temperature) and can be expressed as the number of seconds to gel point. Gel point refers to the point of incipient polymer network formation wherein the structure is substantially ramified such that essentially each unit of the network is connected to each other unit of the network. When a curable composition reaches the gel point, the remaining solvent becomes entrapped within the substantially ramified structure. When the trapped solvent reaches its boiling point, bubbles can be formed in the structure (e.g. the prepreg), resulting in an undesirable product).

As discussed herein, for one or more embodiments, the curable compositions have a gel time of from 70 s to 250 s at 171° C., or from 200 s to 260 s at 150° C. In some instances curable compositions having a gel time that is greater than 250 s at 171° C. can be modified by adding a catalyst and/or an additive, as discussed herein, to adjust the gel time range to from 70 s to 250 s at 171° C., or 200 s to 260 s at 150° C. For some applications, curable compositions having a gel time of less than 200 s at 171° C. can be considered too reactive.

### Process for Curing the Composition

The composition is cured via a dual curing system to form an IPN.

In various embodiments, there are two different reaction systems in the curable composition. One is either the free radical polymerization within the SBC vinyl resin or the vinyl PPO, or between the SBC vinyl resin and the vinyl PPO in the presence of initiators. The other is the condensation reaction between epoxide groups and anhydride groups. In an embodiment, this occurs within SMA40 and multifunctional epoxy resins. These two systems can separately form crosslinked network structures and these two sets of networks can be interpenetrated, forming an IPN.

In various embodiments of the present invention, prepregs can be prepared by admixing the composition described above with a solvent to form a varnish. The varnish can then be incorporated onto a substrate and dried to form a prepreg.

The varnish can be incorporated onto the substrate by any suitable method. Examples include but are not limited to rolling, dipping, spraying, brushing and/or combinations thereof. The substrate is typically a woven or nonwoven fiber mat containing, for instance, glass fibers or paper.

The coated substrate is “B-staged” by heating at a temperature sufficient to draw off solvent in the formulation and optionally to partially cure the formulation, so that the coated substrate can be handled easily. The “B-staging” step is usually carried out at a temperature of from 90° C. to 210° C. and for a time of from 1 minute to 15 minutes. In an embodiment, the coated substrate is dried at a temperature in the range of from 130° C. to 160° C. and is dried for an amount of time in the range of from 2 minutes to 6 minutes. Within the range, a relatively lower drying temperature corresponding to a longer drying time is preferred, for example, drying can take place at 130° C. for 6 minutes in an embodiment, or at 160° C. for 2 minutes in another embodiment.

The substrate that results from B-staging is called a “prepreg.” One or more sheets of prepreg are stacked or laid up in alternating layers with one or more sheets of a conductive material, such as copper foil, if an electrical laminate is desired.

The laid-up sheets are pressed at high temperature and pressure for a time sufficient to cure the resin and form a laminate. The temperature of this lamination (curing) step is usually between 100° C. and 230° C., and is between 165° C. and 190° C. other embodiments. The lamination step may also be carried out in two or more stages, such as a first stage between 100° C. and 150° C. and a second stage at between 165° C. and 190° C. The pressure is usually between 50 N/cm² and 500 N/cm². The lamination step is usually carried out for a time of from 1 minute to 200 minutes, and for 45 minutes to 90 minutes in other embodiments. The lamination step may optionally be carried out at higher temperatures for shorter times (such as in continuous lamination processes) or for longer times at lower temperatures (such as in low energy press processes).

Optionally, the resulting laminate, for example, a copper-clad laminate, may be post-treated by heating for a time at high temperature and ambient pressure. The temperature of post-treatment is usually between 120° C. and 250° C. The post-treatment time usually is between 30 minutes and 12 hours.

In various embodiments, the cured products formed from the curable compositions of the present disclosure, as discussed herein, can have a glass transition temperature of at least 180° C.

For various embodiments, the cured products formed from the curable compositions of the present disclosure, as discussed herein, can have a dielectric constant of less than 3.15 at 1 GHz.

For various embodiments, the cured products formed from the curable compositions of the present disclosure, as discussed herein, can have a dissipation factor of 0.005 or less at 1 GHz; for example, the dissipation factor at 1 GHz can be 0.003 to 0.005.

The prepregs can be used to make electrical laminates for printed circuit boards.

### EXAMPLES

### Ingredients

Ricon® 100 resin (SBC, Styrene Butadiene Random Copolymer with about 70% 1,2 vinyl and 17-27% styrene) from Cray Valley.

SA9000 (Vinyl PPO, vinyl Capped Polyphenylene Ether Oligomer (Mn is about 1600)) from SABIC

DCP(Dicumyl Peroxide) from Sinopharm Chemcial Reagent Co.Ltd

Flame retardant: 1,2-Bis(2,3,4,5,6-pentabromophenyl)ethane from Unibrum

### Examples

### Aniline/SMA 40 Synthesis Procedure

A 100 gram quantity of SMA40 was dissolved in 90 grams of xylene (55% solid content) and was heated to 80° C. A 9.4 gram quantity of aniline was then added dropwise into the SMA/xylene solution. The temperature was maintained at 80° C. for 1 hour. Then a 10 weight percent NaOH aqueous solution was added dropwise as a catalyst. The Na⁺ content is kept at 400ppm in the final product. The mixture was then heated to 146° C. and after 4-5 hours, the mixture was cooled to room temperature.

### Varnish Preparation

A free radical curing reaction occurred between a styrene-butadiene copolymer (SBC) (Ricon® 100) and vinyl poly(phenylene ether) (PPO) (SA9000) in a resin. Ricon® 100 was dissolved in MEK to yield a 50% SBC/MEK solution. SA9000 was then dissolved in MEK to yield a 50% PPO/MEK solution. The SBC and PPO solutions were mixed together and were subsequently mixed with a flame retardant. Free radical initiators were added to yield a homogeneous varnish. DER® 560 and the Aniline/SMA 40 mixture prepared above were weighed and dissolved in MEK to make a 50% varnish solution. The above solutions were then mixed together to yield a homogeneous varnish. The resin formulation was hand-brushed onto 1080 glass fiber fabrics and solvent was removed in a vacuum oven at 171° C. for 3 minutes. Samples were pressed with 8 layers and cured at 220° C. for 3 hours and the properties of the casted samples were tested.

Control Examples A-C and Examples1-5 were prepared according to the formulations listed in Table 1 and cured at conditions listed in Table 1. Thermal and electrical properties were measured and are shown in Table 1.

TABLE 1
Formulation, electrical properties and thermal performance of
SBC/PPO/Ani-SMA40 laminate with formulations.

| | Control A | Control B | Control C | | Example 2 | Example 3 | Example 4 | Example 5 |
|---|---|---|---|---|---|---|---|---|
| | (solid | (solid | (solid | Example 1 | (solid | (solid | (solid | (solid |
| Components | wt/g) | wt/g) | wt/g) | (solid wt/g) | wt/g) | wt/g) | wt/g) | wt/g) |
| SBC | 0 | 0 | 10 | 10 | 10 | 10 | 5 | 9.2 |
| Vinyl PPO | 0 | 10 | 0 | 10 | 5 | 2 | 5 | 4.1 |
| DER560 | 7.3 | 7.3 | 7.3 | 7.3 | 7.3 | 7.3 | 7.3 | 7.3 |
| Ani-SMA40 | 10 | 10 | 10 | 10 | 10 | 10 | 10 | 10 |
| SBC/PPO ratio | / | / | / | 1 | 2 | 5 | 1 | 2.2 |
| (SBC + PPO) wt. % | 0 | 36.6 | 36.6 | 53.6 | 46.4 | 41.0 | 36.6 | 0.77 |
| DCP/g | 0 | 0.2 | 0.2 | 0.4 | 0.3 | 0.24 | 0.2 | 0.27 |
| 2-MI/mg | 30~40 | 0 | 0 | 0 | 0 | 0 | 0 | 0 |
| FR1 | 0 | 4.14 | 4.14 | 8.28 | 6.20 | 5.00 | 4.14 | 3.99 |
| Gel time (171° C.)/s | 250 | 100 | 90 | 70 | 100 | 90 | 90 | 90 |
| Gel time | 260 | 260 | 200 | 200 | 260 | 200 | 200 | 200 |
| (150° C.)/s | | | | | | | | |
| Resin content/% | 76 | 75 | 75 | 76 | 75 | 75 | 75 | 75 |
| Bake condition | 220° C. 2 h | 220° C. 2 h | 220° C. 2 h | 220° C. 2 h | 220° C. 2 h | 220° C. 2 h | 220° C. 2 h | 220° C. 2 h |
| Tg/° C. (DMA) | 190 | 190 | Phase | 180 | 184 | 190 | 181 | 185 |
| | | | separation | | | | | |
| Dk/1 GHz | 3.1 | 3.12 | NA | 3.06 | 3.03 | 3.1 | 3.01 | 3.13 |
| Df/1 GHz | 0.006 | 0.006 | NA | 0.003 | 0.004 | 0.004 | 0.005 | 0.005 |

It can be seen that without SBC, adding PPO into a DER 560 and Ani-SMA40 formulation did not effectively improve Df (Control Examples A and B). Without PPO, the SBC formulation had a phase separation problem when blending with DER560 and Ani-SMA40 due to the polarity difference (Control Example C). PPO and SBC blended with DER560 and Ani-SMA40 at different ratios (Examples 1-5) can effectively improve laminate Df with minimal deterioration of the Tg, especially when increasing the SBC and PPO weight percentage in the composition (Example 1).

### Test Methods

### Board Pressing Procedure

The temperature of the press was increased to 150° C. 24000 pounds of force was exerted at 150° C. This was repeated several times to exhaust the bubbles. The temperature was then increased to 220° C. and was held at that temperature for two hours, after which the board was cooled to room temperature.

### Glass Transition Temperature (T_{g})

The glass transition temperature was determined with a RSA III dynamic mechanical thermal analyzer (DMTA). Samples were heated from −50° C. to 250° C. at a heating rate of 3° C./min. The test frequency was 6.28 rad/s. The Tg of the cured epoxy resin was obtained from the tangent delta peak.

Dielectric Constant (Dₖ)/Dissipation Factor (D_{f})

The dielectric constant and dissipation factor were determined based using the ASTM D-150 test method using an Agilent E4991A RF impedance/material analyzer under 1 GHz at room temperature. The sample thickness ranged from 0.3 to 3.0 millimeters. To obtain a Tier 5 laminate, the Df value should be controlled under 0.005.

### Gelation Time Test

The gel point is the point at which the resin changes from a viscous liquid to an elastomer. The gel time was measured and recorded using approximately 0.7 mL of liquid dispensed on a hot plate maintained at either 150 or 171° C., wherein the liquid was stroked back and forth after 60 seconds on the hot plate until gelation. Results at both temperatures are shown in Table 1.

What is claimed is:

1. A curable composition comprising
a) a styrene-butadiene vinyl resin containing from 30 weight percent to 85 weight percent of 1, 2-vinyl groups and wherein styrene is present in an amount in the range of from 10 weight percent to 50 weight percent;
b) a vinyl poly(phenylene ether) having a number average molecular weight in the range of from 300 to 10000;
c) an aniline modified styrene-maleic anhydride copolymer;
d) a multifunctional epoxy resin; and
e) a flame retardant
wherein, upon curing under curing conditions, the curable composition forms at least one interpenetrating network structure.

2. A composition in accordance with claim 1 wherein the styrene-butadiene vinyl resin has a number average molecular weight in the range of from 500 to 8000.

3. A curable composition according to claim 1, further comprising a free radical initiator selected from the group consisting of 2,2′-azobisisobuytlnitrile, benzoyl peroxide, dicumyl peroxide, a disulfide, and combinations thereof.

4. A curable composition according to claim 1, further comprising a catalyst selected from the group consisting of 2-methyl imidazole, 2-phenyl imidazole, 2-ethyl-4-methyl imidazole, boric acid, triphenylphosphine, tetraphenylphosphonium-tetraphenylborate and mixtures thereof.

5. A curable composition according to claim 1, wherein the styrene-butadiene vinyl resin is present in an amount in the range of from 5 to 40 weight percent, the vinyl poly(phenylene ether) is present in an amount in the range of from 25 to 75 weight percent, the aniline modified styrene-maleic anhydride copolymer is present in an amount in the range of from 25 to 75 weight percent, and the multifunctional epoxy resin is present in an amount in the range of from 25 to 75 weight percent, based on the total weight of the curable composition.

6. A curable composition according to claim 1, wherein the flame retardant is present in an amount in the range of from 1 to 70 weight percent, based on the total weight of the styrene-butadiene vinyl resin and vinyl poly(phenylene ether).

7. A curable composition in accordance with claim 2 wherein the free radical initiator is present in an amount in the range of from 0.01 weight percent to 10 weight percent, based on the total weight of the styrene-butadiene vinyl resin and vinyl poly(phenylene ether).

8. A curable composition according to claim 1, wherein the curing conditions comprise a curing temperature in the range of from 100° C. to 230° C. and a curing time in the range of from 1 minute to 200 minutes.

9. A process comprising
a) admixing
i) a styrene-butadiene vinyl resin containing from 30 weight percent to 85 weight percent of 1,2-vinyl groups and wherein styrene is present in an amount in the range of from 10 weight percent to 50 weight percent;
ii) a vinyl poly(phenylene ether) having a number average molecular weight in the range of from 800 to 10000;
iii) an aniline modified styrene-maleic anhydride copolymer:
iv) a multifunctional epoxy resin; and
v) a flame retardant
to form a curable composition and
b) curing the curable composition under curing conditions to form a cured product having an interpenetrating polymer network.

10. A process in accordance with claim 9 further comprising admixing in step a) a fre radical initiator selected from the group consisting of 2,2′-azobisisobuytlnitrile, benzoyl peroxide, dicumyl peroxide, a disulfide, and combinations thereof.

11. A process according to claim 9, wherein the styrene-butadiene vinyl resin is present in the curable composition in an amount in the range of from 5 to 40 weight percent, the vinyl poly(phenylene ether) is present in an amount in the range of from 25 to 75 weight percent, the aniline modified SMA is present in an amount in the range of from 25 to 75 weight percent, and the multifunctional epoxy resin is present in an amount in the range of from 25 to 75 weight percent, based on the total weight of the curable composition.

12. A process according to claim 9, wherein the flame retardant is present in the curable composition in an amount in the range of from 1 to 70 weight percent, based on the total weight of the styrene-butadiene vinyl resin and the vinyl poly(phenylene ether).

13. A process in accordance with claim 10 wherein the free radical initiator is present in the curable composition in an amount in the range of from 0.01 weight percent to 10 weight percent, based on the total weight of the styrene-butadiene vinyl resin and the vinyl poly(phenylene ether).

14. A process according to claim 9, wherein the curing conditions comprise a curing temperature of from130° C. to 160° C. and a curing time of from 2 minutes to 6 minutes.

15. A prepreg prepared from the curable composition of claim 1.

16. An electrical laminate prepared from the curable composition of claim 1.

17. A printed circuit board prepared from the curable composition of claim 1.

18. A curable composition according to claim 2, further comprising a free radical initiator selected from the group consisting of 2,2′-azobisisobuytlnitrile, benzoyl peroxide, dicumyl peroxide, a disulfide, and combinations thereof and a catalyst selected from the group consisting of 2-methyl imidazole, 2-phenyl imidazole, 2-ethyl-4-methyl imidazole, boric acid, triphenylphosphine, tetraphenylphosphonium-tetraphenylborate and mixtures thereof.

19. A curable composition according to claim 2, wherein the styrene-butadiene vinyl resin is present in an amount in the range of from 5 to 40 weight percent, the vinyl poly(phenylene ether) is present in an amount in the range of from 25 to 75 weight percent, the aniline modified styrene- maleic anhydride copolymer is present in an amount in the range of from 25 to 75 weight percent, and the multifunctional epoxy resin is present in an amount in the range of from 25 to 75 weight percent, based on the total weight of the curable composition and the flame retardant is present in an amount in the range of from 1 to 70 weight percent, based on the total weight of the styrene-butadiene vinyl resin and vinyl poly(phenylene ether).

20. A curable composition according to claim 2, further comprising a free radical initiator selected from the group consisting of 2,2′-azobisisobuytlnitrile, benzoyl peroxide, dicumyl peroxide, a disulfide, and combinations thereof, and the free radical initiator is present in an amount in the range of from 0.01 weight percent to 10 weight percent, based on the total weight of the styrene-butadiene vinyl resin and vinyl poly(phenylene ether).
